(19) United States
(12) Patent Application Publication
(10) Pub. No.: US 2010/0042287 A1
(43) Pub. Date: Feb. 18, 2010

(54) PROACTIVE VEHICLE SYSTEM MANAGEMENT AND MAINTENANCE BY USING DIAGNOSTIC AND PROGNOSTIC INFORMATION

(75) Inventors: XIAODONG ZHANG, Mason, OH (US); William C. Lin, Birmingham, MI (US); Yilu Zhang, Northville, MI (US); Mutasim A. Salman, Rochester Hills, MI (US); Yuen-Kwok Chin, Troy, MI (US); Steven W. Holland, St Clair, MI (US); Mark N. Howell, Rochester Hills, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/190,322

(22) Filed: Aug. 12, 2008

(51) Int. Cl. G06F 19/00

(52) U.S. Cl. 701/33

(57) ABSTRACT

A system and method for providing proactive vehicle system management and maintenance using diagnostic and prognostic information. Vehicle information is collected from vehicle sensors and/or sub-systems by an on-board module on the vehicle and/or at a remote facility where the information is wirelessly transmitted to the remote facility. The collected information is analyzed to determine the health of various systems, sub-systems and components so that the remaining useful life of the systems, sub-systems and components can be predicted. By utilizing the diagnostic and prognostic information, a vehicle control strategy can be reconfigured to minimize customer impact. Further, if a software problem is detected, temporary or permanent software fixes can be provided automatically and remotely through a remote service garage.

### BACKGROUND OF THE INVENTION

1. Field of the Invention

This invention relates generally to a system and method that provides vehicle system management and maintenance by using diagnostic and prognostic information and, more particularly, to a system and method that provides vehicle system management and maintenance by using diagnostic and prognostic information where vehicle sensor data and information is collected on-board or remotely from vehicle sub-systems and components, the current health status of the sub-systems and components is assessed and the remaining useful life of the sub-systems and components is predicted.

2. Discussion of the Related Art

Vehicles employ many systems, sub-systems and components. Each of these systems, sub-systems and components typically have a certain useable life, and may fail for one reason or another during operation of the vehicle. Because failure of the various systems, sub-systems and components may be inconvenient, or otherwise, for a vehicle owner, it may be desirable to predict the life of the various systems, sub-systems and components so that appropriate maintenance and/or part replacement can be performed before the system, sub-system or component actually fails, thus increasing the quality or perceived quality of the vehicle.

Much information can be obtained from vehicle systems, sub-systems and components at different locations associated with the vehicle and its production and use, such as dealerships, suppliers, engineering production managers, customer relations personnel, etc. Thus, it may be desirable to provide a process for obtaining information from all of the various locations related to vehicle design, development and use so that information concerning the vehicle systems, sub-systems and components can be better obtained, and better decisions concerning the diagnosis and prognosis of the systems, sub-systems and components can be provided.

Typical vehicle analysis concerning the failure of systems, sub-systems and components has to do with diagnostics where once such a system, sub-system or component has failed, appropriate personnel typically determine the root cause of the failure. Vehicle manufacturers would be better served to identify the prognosis of the various systems, sub-systems and components to predict their useful life and take necessary action prior to the system, sub-system or component actually failing. In other words, it may be desirable to determine the state of health of the various systems, sub-systems and components on a vehicle. Further, such prognostic types of analysis will have significant benefits from a cost perspective where instead of replacing systems, sub-systems and components, the system, sub-system or component may be able to be fixed prior to it failing.

### SUMMARY OF THE INVENTION

In accordance with the teachings of the present invention, a system and method are disclosed for providing proactive vehicle system management and maintenance using diagnostic and prognostic information. Vehicle information is collected from vehicle sensors and/or sub-systems by an on-board module on the vehicle and/or at a remote facility where the information is wirelessly transmitted to the remote facility. The collected information is analyzed to determine the health of various systems, sub-systems and components so that the remaining useful life of the systems, sub-systems and components can be predicted. By utilizing the diagnostic and prognostic information, a vehicle control strategy can be reconfigured to minimize customer impact. Further, if a software problem is detected, temporary or permanent software fixes can be provided automatically and remotely through a remote service garage.

Additional features of the present invention will become apparent from the following description and appended claims, taken in conjunction with the accompanying drawings.

### BRIEF DESCRIPTION OF THE DRAWINGS

FIG. 1 is an illustration of a vehicle wirelessly linked to a remote information facility; and

FIG. 2 is a block diagram of a vehicle management and maintenance system that uses diagnostic and prognostic information.

### DETAILED DESCRIPTION OF THE EMBODIMENTS

The following discussion of the embodiments of the invention directed to a proactive vehicle system management and maintenance process that collects vehicle diagnostic and prognostic information to determine vehicle state of health and/or predict the useful life of vehicle systems, sub-systems and components is merely exemplary in nature, and is in no way intended to limit the invention or its applications or uses.

As will be discussed below, the present invention proposes a proactive vehicle system management and maintenance method that uses diagnostic and prognostic information. Vehicle data is collected on-board the vehicle and/or at a remote location from vehicle systems, sub-systems and components and is analyzed, and the state of health of the systems, sub-systems and components is assessed to determine the remaining useful life of the systems, sub-systems and/or components. By utilizing diagnostic and prognostic information, vehicle systems can be reconfigured to minimize customer impact. Additionally, if a software problem is detected, temporary or permanent software fixes can be provided automatically and remotely through a service garage, which saves service time.

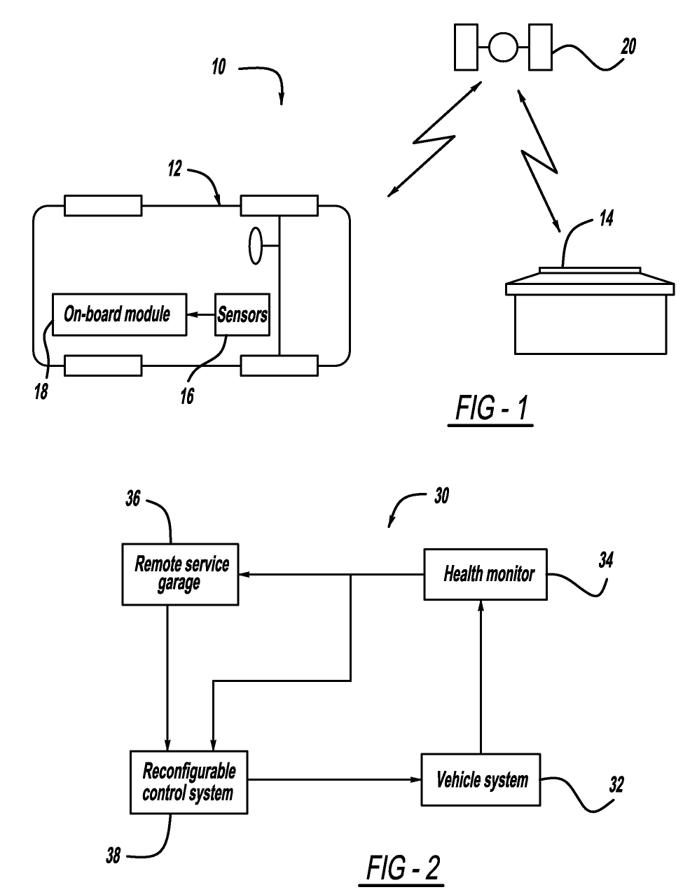

FIG. 1 is an illustration of a proactive vehicle management and maintenance system 10 including a vehicle 12 and a remote information collection facility 14. The vehicle 10 includes sensors 16 that represent various sensors, detectors and components on the vehicle 12 that monitor various systems, sub-systems and components on the vehicle 12, and provide trouble codes and fault codes concerning possible faults of systems, sub-systems and components on a vehicle data bus. The vehicle information collected by the sensors 16 is sent to an on-board module 18 that processes the information, and may provide analysis of the information depending on the amount of computing power that the on-board module 18 has and the level of analysis that the vehicle is designed to provide. Alternately or additionally, the data collected by the on-board module 18 can be wirelessly transmitted by the vehicle 12 to the remote facility 14 through a satellite network, represented by satellite 20.

The information that is transmitted to the satellite 20 from the vehicle 12 can then be received by the remote information facility 14 on the satellite down-link, where the information can be assessed and analyzed. If there is a problem with a certain vehicle system, sub-system or component, the remote information facility 14 can transmit a signal back to the vehicle 12 through the satellite 20 to provide certain proactive actions that may repair or mitigate the problem that is on the vehicle 12. For example, if the sensors 16 on the vehicle 12 determine that the vehicle generator may not be operating properly and may not be charging the vehicle battery, signals from the vehicle 12 to the remote information facility 14 can indicate the problem and the remote information facility 14 may transmit signals back to the vehicle 12 that turn certain systems off or reduce power so that the battery state of charge is not drained as quickly. Further, a warning can be given to the vehicle driver, who would then have time to take the vehicle 12 to a service facility before the battery state of charge is completely drained. Further, if certain faults are detected on the vehicle 12, the remote information facility 14 can transmit codes to the vehicle 12 that may reprogram algorithms that may mitigate or correct certain problems that are detected.

Vehicle health monitoring detects anomalies, determines faulty components and sub-systems and predicts remaining useful life of the components and sub-systems. Upon the detection of a software problem, the vehicle 12 can be remotely reprogrammed through a remote service garage. In the presence of a fault that cannot be fixed remotely, such as hardware failure, an on-board vehicle management system can safely degrade the system to minimize customer impact.

FIG. 2 is a representation of a proactive vehicle management and maintenance system 30 of the type discussed above. The vehicle 12 and its various systems, sub-systems and components are represented as vehicle system 32. A vehicle health monitoring processor 34 proactively collects diagnostic and prognostic data from the vehicle system 32 and monitors the state of health at the component and sub-system level through model-based and/or data-driven approaches. The health monitoring processor 34 can either be performed in the on-board module 18 or at the remote information facility 14 or both. If any abnormal behavior is detected, the vehicles current health status is assessed, and the remaining useful life of sub-systems and components can be predicted.

The determination of the health of a particular vehicle sub-system or component by the processor 34 can then be transmitted to a remote service garage 36 and/or a reconfigurable control system 38. If a software problem is detected by the processor 34 diagnostic and/or prognostic data can be transmitted to the remote service garage 36 through a vehicle-to-infrastructure architecture. When the remote service garage 36 receives the diagnostics/prognostic information, it can perform further analysis of the data and determine a suitable course of action, such as a software update or correction. Whenever applicable, the remote service garage 36 can remotely update or reprogram the control software on the vehicle 12 using the wireless link. In addition to the remote software update/reprogramming, the reconfigurable control system 38 can utilize the diagnostic and prognostic information to reconfigure control strategies to enhance vehicle safety and to avoid walk home situations, therefore minimizing impact of faults on the customer. For example, if an alternator failure is detected, the convenience and entertainment loads can be turned off to ensure that the power supplies safety features and provide the customer some time to drive to a dealer garage so the alternator can be replaced.

The remote self updating and correction would necessarily be performed at an appropriate time during vehicle operation so that it did not affect other performance issues with the vehicle.

Upon the detection of a software bug leading to a parasitic load, the vehicle can automatically send a request to the service garage 36 for software reprogramming, which can be completed remotely through a suitable service provider, such as OnStar™.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A proactive vehicle management and maintenance system that provides vehicle diagnosis and prognosis, said system comprising:
an on-board module on the vehicle that collects vehicle information from vehicle sensors and sub-systems;
a health monitoring processor that receives information from the on-board module and uses the information to determine the state of health of vehicle systems, sub-systems and components;
a remote service garage that receives diagnosis and prognosis information from the health monitoring processor and provides remote software updates to the vehicle; and
a reconfigurable control sub-system on the vehicle that reconfigures vehicle systems, sub-systems and components to mitigate a particular problem detected by the health monitoring processor.

2. The system according to claim 1 wherein the health monitoring processor is on the vehicle.

3. The system according to claim 1 wherein the health monitoring processor is at a remote location from the vehicle.

4. The system according to claim 1 wherein the vehicle and the health monitoring processor and the vehicle and the remote service garage are connected by a wireless communications link.

5. The system according to claim 4 wherein the wireless communications link between the vehicle and the health monitoring processor and the health monitoring processor and the remote service garage use satellite communications.

6. The system according to claim 1 wherein the reconfigurable control sub-system reduces the power drain on a vehicle battery by turning certain systems off if a problem with the battery state of charge is detected.

7. A proactive vehicle management and maintenance system comprising:
a plurality of vehicle sensors and sub-systems that collect information concerning various components and sub-systems on the vehicle;
an on-board module on the vehicle that collects vehicle diagnosis and prognosis information from the vehicle sensors and sub-systems; and
a remote facility that receives the collected information wirelessly from the vehicle, analyzes the collected information, and transmits a signal back to the vehicle to take certain actions to reduce or mitigate potential vehicle problems.

8. The system according to claim 7 wherein the remote facility transmits programming information to the vehicle to change or revise algorithms on the vehicle to address a vehicle problem.

9. The system according to claim 7 wherein the remote facility sends signals to the vehicle to reconfigure certain vehicle components to reduce or mitigate a vehicle problem.

10. The system according to claim 7 wherein the remote facility reduces the power drain on a vehicle battery by turning certain systems off if a problem with the battery state of charge is detected.

11. The system according to claim 7 wherein the wireless link between the vehicle and the health monitor processor and remote facility use satellite communications.

12. A method for managing and maintaining vehicle systems, sub-systems and components from a remote location from a vehicle, said method comprising:
collecting information on the vehicle concerning the status of various vehicle sub-systems and components;
analyzing the collected information to determine whether a problem exists from the collected information;
transmitting the information to a remote facility if a vehicle problem is detected; and
transmitting signals from the remote facility to the vehicle that takes corrective or mitigating action to address the vehicle problem.

13. The method according to claim 12 wherein the remote facility sends signals to the vehicle to reprogram or update algorithms associated with the vehicle to address the vehicle problem.

14. The method according to claim 12 wherein the signals sent from the remote facility reconfigure certain vehicle systems to address the vehicle problem.
